(19) United States
(12) Patent Application Publication
(10) Pub. No.: US 2016/0069294 A1
(43) Pub. Date: Mar. 10, 2016

(54) TWO-PART STEEL PISTON, JOINING PROCESS

(71) Applicant: KS KOLBENSCHMIDT GMBH, Neckarsulm (DE)

(72) Inventor: Robert KÜHNEL, Heilbronn (DE)

(73) Assignee: KS Kolbenschmidt GmbH, Neckarsulm (DE)

(21) Appl. No.: 14/776,966

(22) PCT Filed: Mar. 14, 2014
(86) PCT No.: PCT/EP2014/055117

§ 371 Date: Sep. 15, 2015

(30) Foreign Application Priority Data
Mar. 15, 2013 (DE) 10 2013 204 630.8

(51) Int. Cl. F02F 3/00

(52) U.S. Cl. CPC F02F 3/0015; F02F 3/0092

(57) ABSTRACT

A piston, such as a cooling channel piston, for an internal combustion engine, including at least one lower part and one upper part, a combustion chamber and at least one annular groove. The upper part or the lower part is fastened by means of at least one undercut on the lower part or on the upper part. The upper part includes at least one combustion chamber and at least one annular groove. A method for producing such a piston is disclosed.

### BACKGROUND

The disclosure relates to a piston and a method for producing a two-piece piston from an upper part and a lower part.

EP 1 8878 8902 A2 describes the construction of a piston made from an upper part and a lower part that are supported in the area of contact zones by connecting webs and are joined to each other. A clamped joint is created here by rotating the upper part relative to the lower part, comparable to a clutch. This is very complicated in the handling phase.

Creating a connection between upper part and lower part of a piston for an internal combustion engine by positive locking is known from DE 10 2005 030 556 B4. The disadvantage here is that the upper part joined by a positive locking connection forms only one part of the piston crown.

### SUMMARY

A piston, in particular the cooling channel piston, consists of an upper part and a lower part. A cooling channel can be, but does not have to be, introduced into the upper part. The upper part comprises the upper surface facing the combustion chamber of the piston, the ring belt in an intrinsically known manner and, when required, a combustion bowl. The lower part consists of load-bearing skirt wall sections disposed opposite each other, connecting walls that connected the skirt wall sections, wherein the piston pin bores are located in an intrinsically known manner. The two parts may consist of the same material or of different materials. If the piston in question is a cooling channel piston, a cover for the cooling channel may be provided before upper part and lower part are joined, wherein this cover is created by the joining of the two parts in their final location. Alternatively or supplementally, the cover can also be located independently of the clamping process after the joining of the two parts or, if it was clamped by the upper and lower part, located when in its final position by additional measures such as welding or similar and sealed by these additional measures. The two parts can be produced by the same method or by different methods, such as forging, casting or similar.

It would be desirable to eliminate the disadvantageous dividing plane between lower part and upper part of a piston.

It is proposed to manufacture the upper part with combustion bowl and ring belt and an optional cooling channel in one piece.

Compared with the prior art, it is advantageous to strive for unidirectional joining.

Provision is made for the upper part to include at least one combustion chamber and at least one ring groove. A joint in which at least two component to be connected engage each other mechanically and, because of the geometric shape of the components to be joined in the area of the connection, the connection remains intact, is described as a positive locking joint. Even if no transfer of force takes place between the components to be connected, or if the transfer of force between the components to be connected is interrupted, the connection is maintained. Joints with an undercut, riveted joints or dovetail joints are, for example, counted among positive locking joints.

A piston, such as a cooling channel piston, for an internal combustion engine, has at least one lower part and an upper part, as well as a combustion chamber and at least one ring groove, wherein the upper part or the lower part is anchored with at least one undercut to the lower part or to the upper part, and wherein the upper part includes at least one combustion chamber and at least one ring groove.

Furthermore provision is made for the at least one undercut to be an integral part of the wall of an opening. The undercut can advantageously be produced in one operating step with the opening.

Provision is furthermore made for at least one stud to engage the undercut following the forming process. In this way a strong, positive locking joint is made by incorporating the undercut. The joint is practically non-detachable and can only be separated, if at all, by applying very great force.

Provision is furthermore made for the volume of the stud to match the volume of the opening almost exactly. This ensures that the stud fills the entire opening, which is, for example, cylindrical. This results in a secure, high-strength connection. The opening is almost cylindrical in shape, wherein it has a smaller diameter at the point where the stud enters than at the opposite end. The opening is delimited by a wall that corresponds to the lateral surface of a truncated cone, wherein the truncated cone faces in the direction of the stud with its “point.” “Almost exactly” in this context means that the volume of the stud (the volume that is to be positioned in the opening) may be smaller than, or at most equal to, the volume of the opening.

Provision is furthermore made for at least one closing element, specifically a ring, to be provided to seal a cooling channel.

A closing element of this kind is configured as a single piece, but can also be multi-piece, e.g. from two or more than two pieces. In addition, depending on the shape of the cooling channel, the at least one closing element is adapted to the geometry of the cooling channel. If the cooling channel is rotationally symmetrical (for example, with respect to the piston stroke axis), the single piece of the closing element (or the several pieces that form the closing element), is configured rotationally symmetrical. However, if the geometry of the cooling channel is not rotationally symmetrical (e.g. oval, ellipsoid or other geometries), the at least one closing element is adapted accordingly, that is to say, also not configured rotationally symmetrical.

Provision is made for a method to produce a two-piece piston, specifically a cooling channel piston, for an internal combustion engine, with a lower part and an upper part, comprising the following steps,

Delivery of the lower part having at least one opening or at least one stud, delivery of the upper part having at least one stud or at least one opening, wherein, with the application of force, the at least one stud fills the undercut of the at least one opening.

Provision is made for the at least one stud to be heated at least to a temperature considerably above ambient temperature before the joining process. This facilitates the joining process because the material to be joined is more easily formed.

“Ambient temperature” is normally understood to mean the temperatures in which the production process for such piston is carried out. Temperatures are involved that can be tolerated by the persons who work in such production sites. The temperature to which the at least one stud is heated before joining is thus significantly higher than this ambient temperature, for example, well above 100 degrees Celsius. If the joining process entails cold forging or hot forging, temperatures well above 200 degrees Celsius are possible. For example, semi-hot forging is performed in the temperature range above 300 degrees Celsius (+/−20%). With hot forging, temperatures are considerably higher.

Provision is furthermore made for a ring to be inserted to form a cooling channel before the lower part and the upper part are joined. In this way a piston with cooling channel can be created without a change of tools.

Provision is furthermore made for at least one ring groove to be introduced into the upper part after the connection is made. Ring grooves serve to receive piston rings in order to use at least one piston in an internal combustion engine.

Provision is furthermore made for an inseparable, positive-locking connection to be created between lower part and upper part. This produces a quasi-one-piece piston that can, however, be manufactured from different materials. These materials do not have to be conducive to a material-to-material connection because in accordance with the invention a high-strength positive-locking connection is created.

The positive lock is configured such that it resists the forces to which it is exposed during operation in an internal combustion engine. These are principally forces whose vector runs parallel to the longitudinal center axis of the piston.

### DETAILED DESCRIPTION OF THE DRAWINGS

More details of the piston and method of making the same are explained in conjunction with the Figures in which:

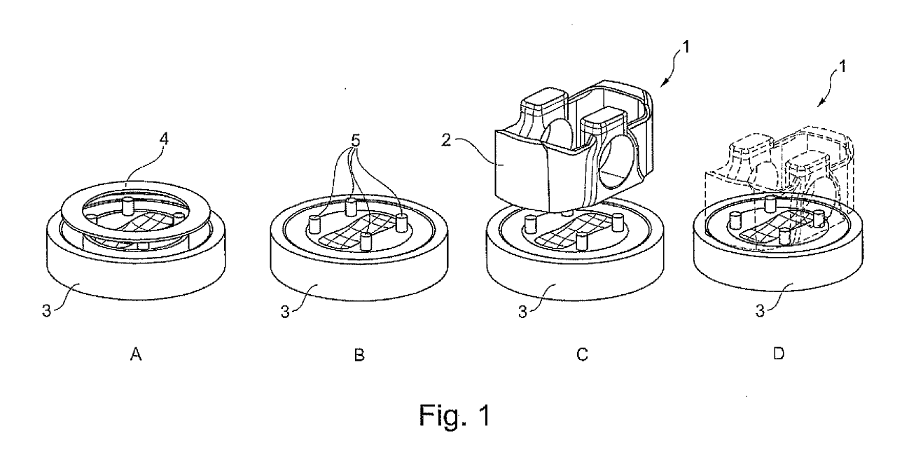

FIGS. 1A to 1D are perspective views showing of the underside of the piston upper part and the progression of preparations for the joining process between lower and upper part of the piston;

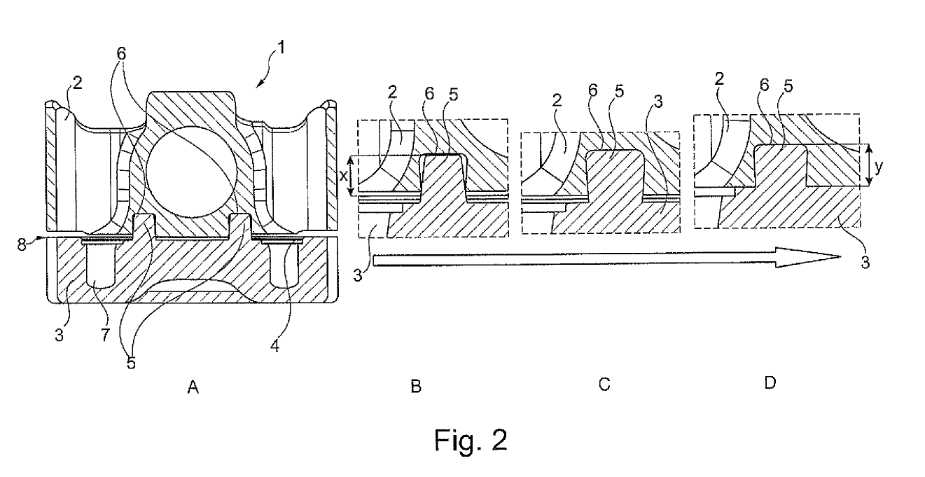

FIGS. 2A to 2D are cross sectional views showing, in schematic form, the progression of the joining process for a piston;

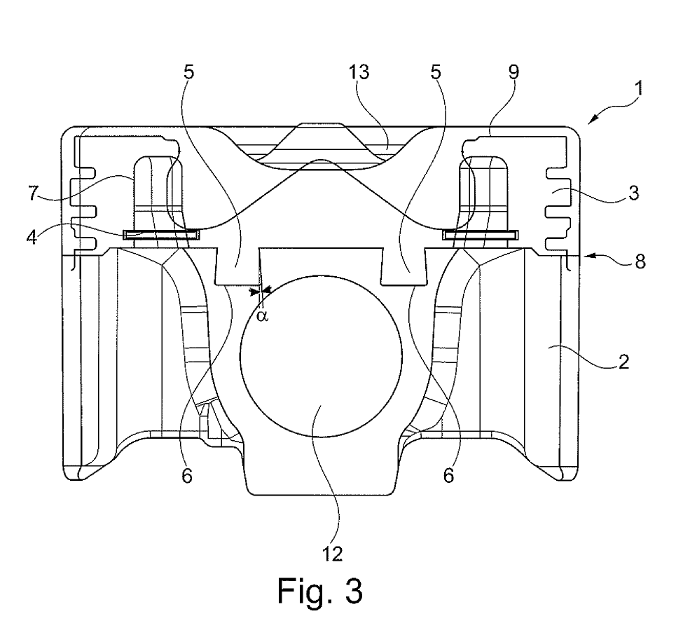

FIG. 3 shows a sectioned view of a piston blank; and

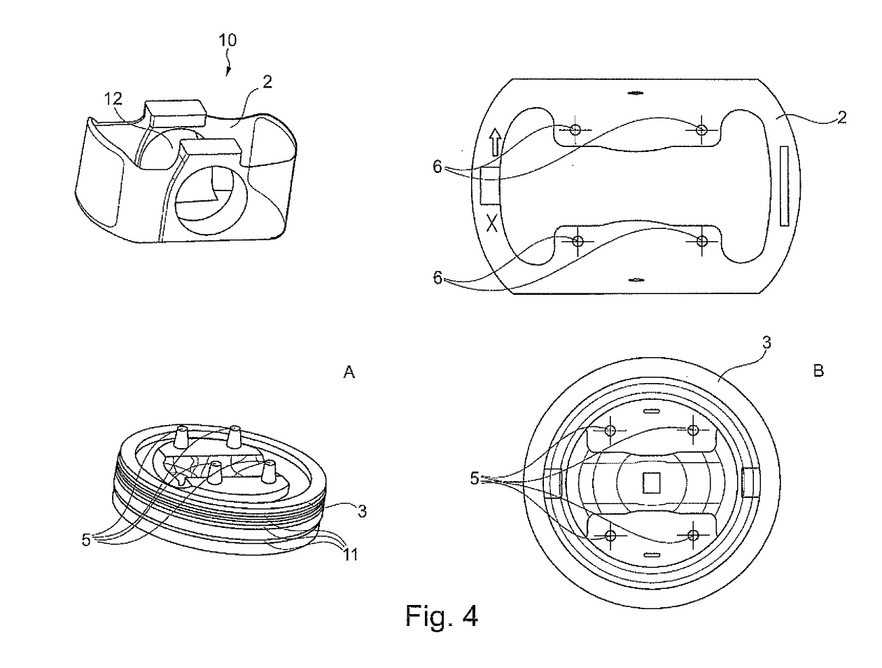

FIGS. 4A to 4D show several views of the piston parts.

### DETAILED DESCRIPTION

In the description of the Figures that follows, terms such as top, bottom, left, right, front, rear, etc. refer solely to the representation and position of the device and other elements chosen as an example in the respective Figures. These terms are not to be understood in a restrictive sense, that is to say, these references can change as the result of different positions and/or mirror-image layout or similar.

FIGS. 1A to 2D show the joining process using the example of a cooling channel piston. The method is not restricted to a cooling channel piston, as pistons without a cooling channel can be manufactured using the method in accordance with the invention.

All of the FIGS. 1A to 1D show a plan view of the underside (in the operating position) of an upper part 3 of a piston blank 1.

A ring 4 to form a cooling channel 7, FIG. 2A, is introduced into the upper part 3 which is lying on its head. When the lower part 2 is later delivered and the joining method has been applied, the ring 4 is anchored between lower part 2 and upper part 3. The ring 4 then tightly seals the open space lying thereunder (above in the operating position) to form the cooling channel 7.

FIG. 1B shows the upper part 3 with the inserted ring 4 and studs 5 before the lower part 2 is connected. Four studs 5 forming a positive-locking joint between lower part 2 and upper part 3 are clearly recognizable in this instance. However, only two studs 5 or more than four studs 5 can also be provided.

FIG. 1C shows how the lower part 2 is delivered before the joining process. The studs 5 specifically can be heated to a temperature considerably above ambient temperature prior to the joining process. This facilitates the subsequent forming process.

FIG. 1D shows the now single-piece piston blank, produced from the lower part 2 and the upper part 3. The transparent representation of the lower part 2 renders visible the shaping of the studs 5 following the joining process.

FIGS. 2A to 2D show sectional views in the area of the joint, similar to FIGS. 1A to 1D. FIG. 2D clearly shows that the stud 5 completely fills the matching shape of an opening 6 after the forming process.

FIGS. 2A and 2B show the delivery of the lower part 2 before the joining process. FIG. 2B further shows that the dimension X of the stud 5 prior to the joining process is greater than the tightened dimension Y in FIG. 2D after the joining process. These dimensions X and Y refer to the height of the stud 5 measured from the dividing plane 8. The “superfluous” material of the stud 5, regarded vertically, is calculated such that it completely fills the opening 6 after the joining process. The angle α indicated in FIG. 3 makes clear that the opening 6 has an undercut. The “superfluous” material of the stud 5 is pressed into the area of the undercut during the joining process. The amount of material in the stud 5 must be matched precisely to the volume of the opening 6 so that the upper part 3 and the lower part 2 can be joined in the dividing plane lying flat on top of each other. The volume of the stud 5 before and after the joining process thus exactly matches the volume of the opening 6. At least the studs 5 can be heated before the joining process to a temperature considerably above ambient temperature, which facilitates the forming process and allows the material of the stud 5 almost to flow into the opening 6. Upon completion of the joining process, the lower part 2 and the upper part 3 are connected inseparably to form a piston blank 1. The ring grooves, for example, are introduced into the upper part 3 in further processing steps.

The piston blank 1 is shown in FIG. 3 in cross-section through the joint location. A line 9 is drawn in to reproduce the later outer contour of a piston 10. It can also be seen that the joint locations lie above, next to a piston pin bore 12. Sufficient material is available here to ensure a solid, secure connection between lower part 2 and upper part 3. The dividing plane between lower part 2 and upper part 3 is identified by 8 in FIG. 3.

FIG. 4A shows a perspective view of a piston 10 produced, wherein the lower part 2 and the upper part 3 are shown separated. FIG. 4B in turn shows a plan view of the lower part 2 and the upper part 3 in the dividing plane 8. Ring grooves 11 have already been cut in FIG. 3 in the upper part 3, marked by the line 9. If the components 2 and 3 are joined, intellectually a finished piston 10 is the result.

In both the detailed description section and in the description of the Figures, the term “opening” (given the reference numeral 6 in the description of the Figures) is used in the sense that in the upper part (general), or in the upper part 3 (in accordance with the embodiment), a volume is removed (recess) in the which the stud (general), or reference numeral 5 in the description of the Figures, is introduced and formed. The stud is formed by the lower part (general, or lower part 2 in the embodiment). It is also conceivable that the at least one recess is in the lower part and the at least one corresponding stud is an integral part of the upper part. It is essential that stud and recess (or opening) are matched to each other such that the volume of the stud after forming fills the volume of the recess (opening). As a result of the plastic deformation of the stud, the stud “bites fast” in the opening so that upper part and the lower part are joined inseparably in the sense that the upper part and the lower part are no longer located moveable relative one to the other. It would be possible to separate upper part and lower part only as the result of forces that do not occur in operation and are thus unusually high forces.

What is claimed:

1. A piston for an internal combustion engine, with at least one lower part and one upper part and a combustion chamber and with at least one ring groove, wherein one of the upper part or the lower part is anchored with at least one undercut in the lower part or in the upper part, characterized in that the upper part includes at least one combustion chamber and at least one ring groove.

2. The piston from claim 1, wherein the at least one undercut is an integral part of the wall of an opening.

3. The piston from claim 2, wherein at least one stud engages the undercut after being deformed.

4. The piston from claim 3, wherein the volume of the stud matches almost exactly the volume of the opening.

5. The piston from claim 1, wherein at least one closing element, is provided to close off a cooling channel.

6. A method for producing a two-piece piston, in particular a cooling channel piston, for an internal combustion engine, with a lower part and an upper part, comprising:
delivering the lower part having at least one opening or at least one stud; and
delivering the upper part having at least one stud or at least one opening; and
filling the at least one opening by the at least one stud, with the application of force.

7. The method from claim 6, comprising heating the at least the at least one stud to a temperature considerably above ambient temperature before the joining process.

8. The method from claim 6, comprising inserting a ring to form a cooling channel before the lower part and the upper part are joined.

9. The method from claim 6, comprising introducing at least one ring groove into the upper part after the joining process.

10. The method from claim 6, comprising creating an inseparable, positive-locking joint between the lower part and upper part.
